(19) United States
(12) Patent Application Publication
(10) Pub. No.: US 2011/0067728 A1
(43) Pub. Date: Mar. 24, 2011

(54) METHOD AND APPARATUS FOR PERSONAL HYGIENE

(75) Inventors: Neilin Chakrabarty, Calgary (CA); Tapantosh Chakrabarty, Calgary (CA)

(73) Assignees: Neilin Chakrabarty, Calgary (CA); Tapantosh Chakrabarty, Calgary (CA)

(21) Appl. No.: 12/843,015

(22) Filed: Jul. 24, 2010

Related U.S. Application Data
(60) Provisional application No. 61/245,267, filed on Sep. 23, 2009.

(51) Int. Cl. B08B 7/00; B08B 3/10

(52) U.S. Cl. 134/6; 134/84

(57) ABSTRACT

A method and an apparatus for cleaning of the perineal and the adjacent areas of a human body after using a toilet are disclosed. The method comprises cleaning the said areas with dilute soap solution delivered by gravity drainage, or a soap solution-air suspension delivered from a dispenser, and rinsing the cleaned areas with water delivered by gravity drainage or from a water dispenser. The apparatus comprises either reservoirs holding soap solution and rinse water that are hung from a decorative stand, or dispenser for soap solution-air or water-air suspension. Advantages over prior art include portability for indoor and outdoor use, compatibility with a western or a squat toilet, operability with atmospheric pressure water, affordability because of lower cost, acceptability because of easier installation and placement away from the toilet bowl, and comfortability of use by people suffering from itches, inflammation, or hemorrhoids.

This application claims the benefits of the provisional application U.S. 61/245,267 filed on Oct. 23, 2009.

### CROSS-REFERENCE TO RELATED APPLICATIONS

Not applicable

### STATEMENT REGARDING FEDERALLY SPONSORED RESEARCH AND DEVELOPMENT

Not applicable

### REFERENCE TO SEQUENCE LISTING, A TABLE, OR A COMPUTER PROGRAM LISTING COMPACT DISC APPENDIX

Not applicable

### FIELD OF THE INVENTION

The invention relates to personal hygiene and cleanliness. More specifically, it relates to a method and an apparatus for cleaning perineal and adjacent areas after using a toilet.

### BACKGROUND OF THE INVENTION

Cleaning perineal and adjacent areas after using a toilet is important for achieving good personal hygiene and cleanliness in all cultures. Irritations, itches, discomfort, stench, and infections by bacteria, fungi and yeasts may result from leaving those private areas partially clean. To achieve complete cleaning, several methods are in use in the prior art. Cleaning by one hand and pouring water by the other is practiced in many Asian countries using squat toilets. Cleaning by water sprayed from built-in water nozzles in western-styled toilets are also practiced in Japan. Retrofitting of existing toilets with water nozzles have also been proposed, but are not widely practiced in western countries, where toilet paper usage is the preferred method of cleaning.

Cleaning by toilet paper, however, suffers from several shortcomings. First, cleaning is only partial and sometimes more smearing than cleaning occurs. Second, rubbing of the sensitive perineal and adjacent areas with toilet paper creates rashes, itchiness, inflammation and discomfort. Third, rubbing causes fissures which may lead to infection and development of pruitus ani—a condition of chronic itching of the area around the anus. Fourth, rubbing with toilet paper may cause bleeding and pain to people with hemorrhoids. Wet wipes have been proposed to overcome these shortcomings, but are not widely in use as the dirty wet wipes cannot be flushed in the toilet. There then is a need for a western toilet compatible method for cleaning perineal and adjacent areas that is gentler and more effective than toilet paper usage alone. The instant invention provides such a method.

The built-in and retrofitted nozzles (for example, in U.S. Pat. No. 6,192,527) installed in the bowls of western toilets induce a sense of revulsion and a fear of infection to some users. A nozzle connected to a pressurized household water supply mounted on a bathroom wall has also been disclosed in U.S. Pat. No. 5,809,985. The nozzles require above atmospheric pressure water and are not suitable in countries and places where such water is not available. The need for above atmospheric pressure water also renders the nozzles non-portable and unsuitable for outdoor use by campers, hikers, and travelers. There is a need for a method and an apparatus of cleaning perineal and adjacent areas that use water at atmospheric pressure, providing portability and suitability for outdoor use. The instant invention provides such a method and an apparatus.

Despite their documented advantages in preventing diseases like piles and colon cancer, squat toilets are not popular in the western world for several reasons. Toilet paper cannot be used in squat toilets because of the possibility of plugging the plumbing. Washing by hand after using a squat toilet is also not appealing to users in the western countries. There then is a need for a method and an apparatus that obviate at least one drawback of the squat toilets. The instant invention provides such a method and an apparatus.

### BRIEF SUMMARY OF THE INVENTION

It is an object of the invention to provide a method of cleaning of perineal and adjacent areas that is more effective than the toilet paper use method.

It is a further object of the invention to provide a method and an apparatus for cleaning perineal and adjacent areas that are compatible with a western toilet or a squat toilet.

It is a further object of the invention to provide an apparatus for cleaning of perineal and adjacent areas using atmospheric pressure soap solution and/or water.

It is another object of the invention to provide a method for cleaning of perineal and adjacent areas using a small amount of eco-friendly synthetic or natural soap(s).

It is a further object of the invention to provide a method for cleaning of perineal and adjacent areas that leaves very little soap residue in the cleaned areas.

It is also an object of the invention to provide a method and apparatus for cleaning of perineal and adjacent areas that are portable inside or outside a house, and are suitable for hikers, campers and travelers.

Disclosed is a method for cleaning of the perineal and the adjacent areas of a human body, the method comprising cleaning, in the first stage, the said areas with a dilute soap solution fed by gravity drainage, followed by gentle wiping of the said areas with toilet paper, then, in the second stage, rinsing the said areas with water, also fed by gravity drainage, and finally drying the areas with a gentle dabbing with toilet paper.

Disclosed, is also an apparatus for spraying of soap solution and rinse water to the said areas at atmospheric pressure by gravity drainage of each liquid from its respective reservoir through a tube, one end of which is fitted with a device to spray the liquid. The liquid reservoirs are hung from a decorative stand placed near an existing toilet at a height to allow gravity drainage of the soap solution and the rinse water through the flexible tubes. The soap solution or rinse water flow from each reservoir is controlled by squeezing a nipple, activating a pump, or by opening a valve, each attached to one end of the tube connected to each reservoir containing the soap solution or the water.

The soap solution cleaning and wiping with toilet paper in the first stage do most of the cleaning, while the rinsing with water and wiping with toilet paper in the second stage finishes the cleaning and removes any soap residue from sensitive areas. The toilet paper from both stages is disposed of in the flush toilets. The liquid flow assisted by gravity drainage eliminates the need for high pressure water and expensive plumbing. The gravity drainage method also uses much less water than that used in bidets or toilets fitted with nozzles. Unlike the nozzles, which are installed inside the toilet bowl, the tubes for spraying the soap solution and the water in the instant invention are stowed outside the toilet bowl, thereby allaying the fear of infection associated with the use of bidets or water nozzles.

In a second embodiment of the invention, the first stage cleaning is done diluting the soap solution with air, creating a suspension of air in the soap solution, spraying the suspension on the areas to be cleaned, or placing the suspension on toilet paper and gently wiping the perineal and the adjacent areas with the said toilet paper. The second stage rinsing by water is done either by water fed by gravity drainage from the water reservoir or by water dispensed from a dispenser. The soap solution-air suspension may be prepared using a sparger or a mixing device to disperse the air in the soap solution. The use of the soap-air suspension in the first stage reduces the amount of soap solution needed for cleaning. The water from the dispenser maybe made into an air-water suspension by pumping the water through the sparger.

The embodiments of the soap solution and the soap solution-air suspension usage may be practiced with a western toilet or a squat toilet. In a squat toilet where toilet paper cannot be used, wiping is done, according to the instant invention, with a reusable piece of cloth or a blow dryer.

Both embodiments may be used inside or outside the house. For inside the house use, the same apparatus may be moved around from one bathroom to the other. For outdoor use, the whole apparatus may be packed in a motor vehicle, or the reservoirs of the apparatus and the tubes may be carried in a backpack or as a part of a backpack, or carried in a waist belt or as a part of a waist belt.

Advantages of the instant invention over prior art include compatibility with a western toilet or a squat toilet, operability with atmospheric pressure water, portability for outdoor use, affordability because of lower cost, acceptability because of easier installation and placement away from the toilet bowl, and comfortability after use because of more effective cleaning, especially for people suffering from persistent itches, inflammation, or hemorrhoids.

### BRIEF DESCRIPTION OF THE DRAWINGS

FIG. 1 is an apparatus to practice the first embodiment of the invention using gravity drainage of soap solution and rinsing water.

FIG. 2 is a flow diagram of the method to practice the first embodiment of the invention using gravity drainage of soap solution and rinsing water.

FIG. 3 is an apparatus to practice the second embodiment of the invention using soap solution-air suspension and rinsing water drained by gravity.

FIG. 4 is a flow diagram of the method to practice the second embodiment of the invention using soap solution-air suspension and rinsing water drained by gravity.

FIG. 5 is a diagram showing the incorporation of the gravity drainage method in a backpack for outdoor use.

FIG. 6 is a diagram showing the incorporation of the gravity drainage method in a waist belt for outdoor use.

FIG. 7 is an apparatus to practice the invention in a squat toilet using soap solution and water drained by gravity.

FIG. 8 is a flow diagram of the steps to practice the invention using gravity drainage of soap solution and water in a squat toilet.

### DETAILED DESCRIPTION OF THE INVENTION

Definitions of various terms used herein are given below. If a term is not defined below, it should be given the broadest definition in accordance with that in the relevant prior art.

The term “a” or “an” refers to one or more of that entity. The terms “a” or “an”, “one or more” and “at least one” can be used interchangeably herein unless a limit is specifically imposed.

The terms “containing”, contains” and “contain” have the same open-ended meaning as “comprising”, “comprises” and “comprise”.

The terms “including”, “includes” and “include” have the same open-ended meaning as “comprising”, “comprises”, and “comprise”.

The terms “having”, “has”, and “have”, as used herein, have the same open-ended meaning as “comprising”, “comprises”, and “comprise”.

The term perineal area is defined as the area around the anus.

Private areas include perineal area and the frontal private areas of both male and female.

The term frontal private parts include male and female genitals and adjacent areas.

The term gravity drainage means transfer of fluid from point A to point B by the force of gravity.

The term saponification means making soap from oil by reaction with lye (sodium or potassium hydroxide).

A suspension is defined as air droplets surrounded by thin layers of liquid soap solution.

The term sparger is defined as a device that allows air and liquid soap solution to be mixed to create a suspension of air in the liquid soap solution.

The term reservoir is defined as something that can hold a liquid and comes with a lid or a cap that can be opened or closed. It can be made of plastics, rubber, clay, ceramics, composites, carbon steel, aluminum, or stainless steel or any other suitable material. It may be rigid or deformable like a bladder that takes up various shapes.

The terms reservoir and container are used interchangeably.

Composites are defined as materials that are made from more than one material.

By effective cleaning is meant cleaning that does not leave any visible human waste on the toilet paper and no appreciable soap residue in the cleaned areas.

By soap solution is meant soap blended with water.

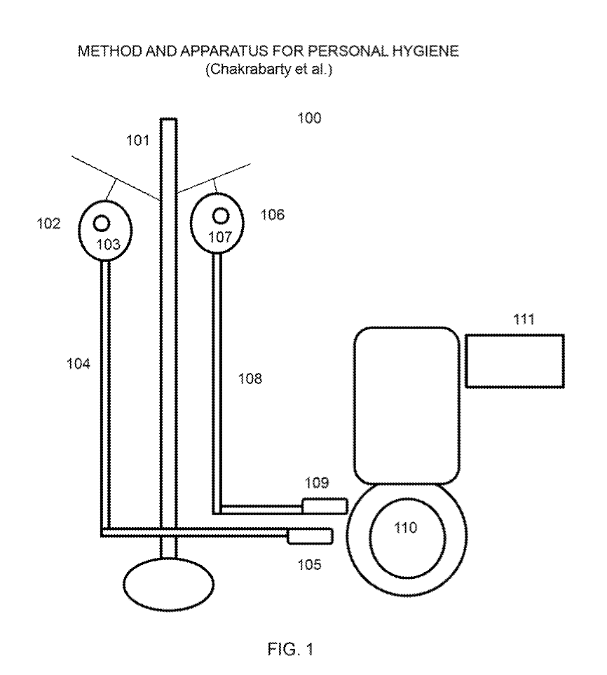

The preferred embodiments of the method and the apparatus of the invention are described below using FIG. 1 to FIG. 8. The method of cleaning comprises two embodiments: cleaning by dilute soap solution fed by gravity drainage followed by rinsing with water fed by gravity drainage, and cleaning by soap solution-air suspension followed by rinsing with water. The apparatus comprises two main embodiments: one for home and the other for outdoor use.

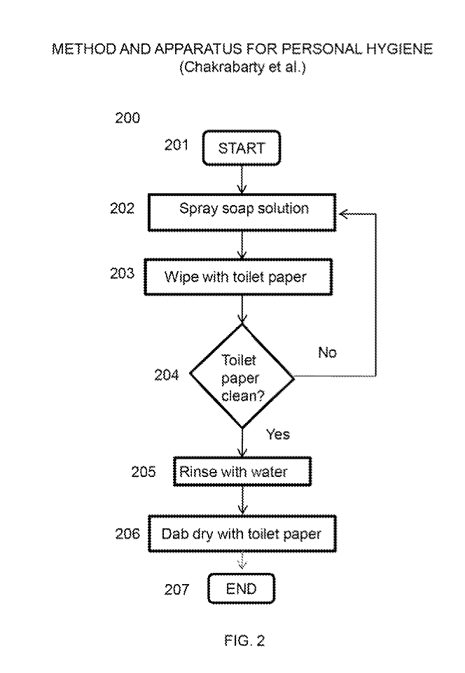

FIG. 1 and FIG. 2 show, respectively, an apparatus and a method of the embodiment of the invention using the gravity drainage of soap solution and water to clean perineal and adjacent areas of a human body.

In FIG. 1, the apparatus 100 includes stand 101, from which reservoir 102 is hung at an elevation at least above the person's waist level while seated on the toilet seat 110. The reservoir 102 is filled with a soap solution in water. The reservoir is made of any suitable materials, including, but not limited to, plastics, rubber, clay, ceramics, composites, carbon steel, aluminum, stainless steel, or any other suitable materials. The reservoir may be rigid or deformable, taking up various shapes. Cap or lid 103 is to fill reservoir 102 with a soap solution. To the bottom of the reservoir 102 is attached a flexible tube 104 made of plastic, rubber or braided stainless steel. The diameter of the flexible tube is ¼ to ½ an inch nominal and the tube can easily be inserted through the space between toilet seat and the human body to access the areas to be sprayed on. The other end of the tube has a nipple, a valve or a pump 105 that remains closed when not activated, but opens while the nipple is squeezed, the valve is opened, or the pump is activated, producing a stream of soap solution that may be sprayed by the user to the perineal and the adjacent areas. The nipple at the end of the flexible tube may be squeezed by pressing between two finger tips to open a slit, through which the soap solution flows. If a valve is used in place of a nipple it can be opened or closed again using finger tips. If a pump is used in place of a nipple or a valve, it can be opened or closed again using finger tips. When not in use, tube 104 is stowed away from the toilet seat 110.

The soap solution in reservoir 102 is any soap solution or surface active agent solution in water that is not harmful to the skin or to the environment. It preferably contains soap made from natural oils. These oils include, but not limited to, olive oil, palm oil, coconut oil, jojoba oil, tea tree oil, aloe vera oil, canola oil, soybean oil or other natural oils. The soap solution may contain emollients, bactericides and preservatives, none of which is harmful to human or to the environment.

From the stand 101 also hangs water reservoir 106 at an elevation at least above the person's waist level while seated on the toilet seat 110. Reservoir 106 is made of any suitable materials, including, but not limited to, plastics, rubber, clay, ceramics, composites, carbon steel, aluminum, or stainless steel or any other suitable materials. The reservoir may be rigid or deformable, taking up different shapes. Cap or lid 107 is to fill reservoir 106 with water. To the bottom of reservoir 106 is attached a flexible tube 108, which is made of plastic, rubber or braided stainless steel. The diameter of the flexible tube is ¼ to ½ an inch nominal and the tube can easily be inserted through the space between toilet seat 110 and the human body—while seated on the toilet seat—to access the perineal and the adjacent areas to be sprayed on. The other end of tube 108 has a nipple, a valve or a pump 109 that remains closed when not in use, but opens while the nipple is squeezed, the valve is opened or the pump is activated, producing a stream of water that may be guided by the user to the perineal and the adjacent areas. When not in use, tube 108 is stowed away from the toilet seat 110.

Item 111 in FIG. 1 is the toilet paper used in steps 203, 206, 403 and 406, as will be discussed later.

FIG. 2 shows the flow diagram of the steps in method 200 involved in cleaning perineal and adjacent areas using the apparatus in FIG. 1. The method starts at 201 when the user is ready to start the cleaning process. The user reaches out to the tip of the flexible tube 104 (FIG. 1) and squeezes the nipple, activates the pump or open the valve 105 to spray dilute soap solution from reservoir 102 (FIG. 1) to the areas to be cleaned. As the solution drains from reservoir 102 by the force of gravity, the user moves the tip around to cover the areas to be cleaned. After 5 to 15 seconds of spraying the soap solution, the flow of soap solution is stopped and the user moves to step 203 to wipe the areas gently with a toilet paper 111 (FIG. 1). No rough rubbing by toilet paper is necessary. Since the area is already wet, the wiping by the toilet paper should not cause any irritation or make fissures in the soap-sprayed areas. Then the user checks in step 204 if the toilet paper is clean or not and throws the used toilet paper in the toilet bowl. If the toilet paper is not clean, the user goes back to step 202 and repeat steps 202, 203 and 204. If the toilet paper is clean, then the user moves to step 205 after disposing of the toilet paper in the toilet bowl and reaches out for the tip of flexible tube 108 (FIG. 1) and squeezes the nipple, activates the pump or open the valve 109 (FIG. 1) to spray water contained in reservoir 106 (FIG. 1) to the areas to be rinsed. As the water drains from reservoir 106 by the force of gravity, the user moves the tip around to cover the target areas. After 5 to 15 seconds of spraying, the water flow is stopped and the user moves to step 206 to dry the areas with a gentle dabbing of the water-rinsed areas with toilet paper 111. As in step 203, no rough rubbing is necessary in step 206. Since the area is already water wet, the dabbing by the toilet paper should not cause any irritation or make fissures in the cleaned areas. The user then throws the water-soaked toilet paper in the toilet, flushes the toilet, cleans the hands with soap solution and water (hand cleaning step not shown in FIG. 2) and completes the cleaning process in step 207, which is the end of the method 200.

The steps shown in FIG. 2 and described above are for illustration only. The order of one or more steps may be changed; one or more steps may be omitted or added without deviating from the scope and the spirit of the invention.

By using soap solution and rinse water, the instant invention achieves more effective cleaning than the prior art method of using toilet paper alone. By gentle wiping of the wet areas with toilet paper, the instant invention prevents or significantly reduces the inflammation, itchiness bleeding caused by rough rubbing by dry toilet paper in the prior art method. By using gravity drainage, the instant invention also makes cleaning by soap solution and water possible in squat toilets in parts of the world where water under pressure is unavailable.

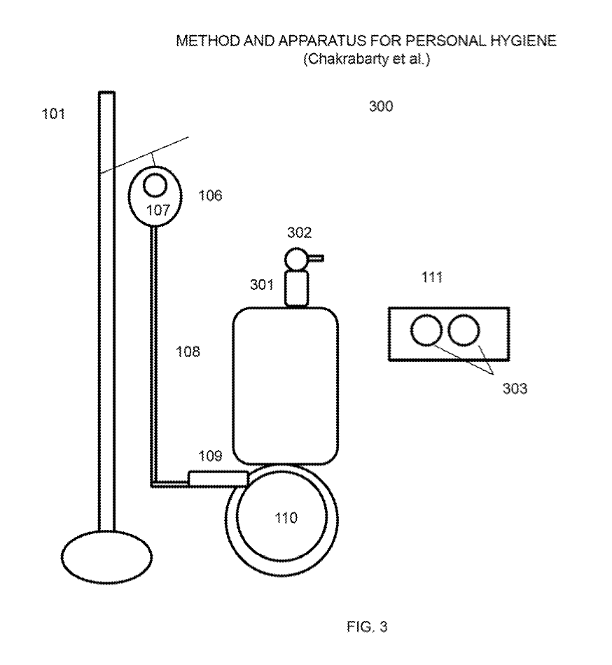

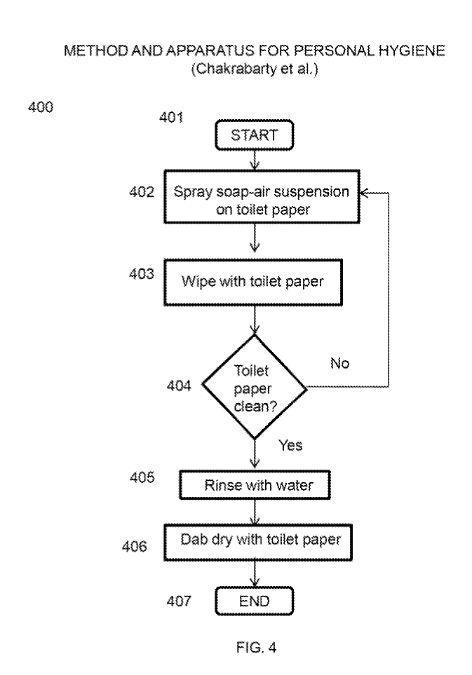

FIG. 3 and FIG. 4 show, respectively, the apparatus and the method of another embodiment of the invention using soap solution-air suspension and rinse water fed by gravity drainage.

In FIG. 3, the apparatus 300 includes stand 101 from which reservoir 106 is hung at an elevation at least above the person's waist level, while seated on the toilet seat 110. Reservoir 106 is filled with water. The reservoir is made of any suitable materials, including, but not limited to, plastics, rubber, clay, ceramics, composites, carbon steel, aluminum, or stainless steel, or any other suitable materials. The reservoir may be rigid or deformable, taking up different shapes. Cap or lid 107 is used to fill reservoir 106 with water. To the bottom of reservoir 106 is attached a flexible tube 108, which is made of plastic, rubber or braided stainless steel. The diameter of the flexible tube is ¼ to ½ an inch nominal and the tube can easily be inserted through the space between toilet seat and the human body to access the areas to be sprayed on. The other end of the tube has a nipple, a valve or a pump 109 that remains closed when not activated, but opens while the nipple is squeezed, the valve is opened or the pump is activated, producing a stream of water that may be guided by the user to the perineal and the frontal private areas.

The soap solution in container 301 is any soap or surface active agent blended with water that is gentle and not harmful to the skin or to the environment. It preferably contains soap made from natural oils. These oils include, but not limited to, olive oil, palm oil, coconut oil, jojoba oil, tea tree oil, aloe vera oil, canola oil, soybean oil, hemp oil and other natural oils. The soap solution may contain emollients, bactericides and preservatives, none of which is harmful to the skin or to the environment. The soap solution is mixed with air by pushing a pump 302 to force the soap solution through a chamber filled with air and fitted with a sparger in the form of sintered metal, fritted glass, porous materials, steel wool or glass beads. The pumping action generates a suspension of air bubbles surrounded by thin layers of the soap solution.

Item 111 in FIG. 3 is a multilayered piece of the toilet paper with two drops 303 of suspension of air in the dilute soap solution, which will be used in steps 403 and 406 to be discussed later.

FIG. 4 shows the flow diagram of the steps in method 400 involved in cleaning the perineal and the adjacent areas using the apparatus in FIG. 3. The method starts at 401 when the user is ready to start the cleaning process. The user makes a suspension of air in soap solution by pressing the suspension making device 302 in container 301 and places one to five drops 303 (FIG. 3) of the suspension on a multilayered piece of toilet paper 111. The number of layers in the toilet paper is chosen such that water from the suspension does not seep through the bottom layer before the suspension is applied to the areas to be cleaned. In step 403, the user applies the piece of the toilet paper with the soap-air suspension to gently wipe the areas to be cleaned. Gentle wiping by wet suspension ensures irritation- and fissure-free cleaning of the sensitive areas. The user checks in step 404 if the toilet paper is clean or not. If the toilet paper is not clean, the user disposes of the used toilet paper in the toilet bowl and goes back to step 402 and repeat steps 402, 403 and 404 in FIG. 4. If the toilet paper is clean, then the user disposes of the used toilet paper in the toilet bowl and moves to step 405 and reaches out for the tip of flexible tube 108 (FIG. 3) and squeezes the nipple, open the valve, or activate the pump 109 (FIG. 3) to spray rinsing water from reservoir 106 to the perineal and the adjacent areas. As the water drains from reservoir 106 by the force of gravity, the user moves the tip around to cover the said areas. After 5 to 15 seconds of spraying, the water flow is stopped and the user moves to step 406 to dry the water-rinsed areas by gentle dabbing with a toilet paper. No rubbing is necessary in this step. Since the area is already wet, the dabbing by the toilet paper should not cause any irritation or make any fissure. The user then throws the water-soaked toilet paper in the toilet, flushes the toilet, cleans both hands with the soap-air suspension from container 301 and water from reservoir 106 (hand cleaning step not shown in FIG. 4), and completes the cleaning process in step 407, which is the end of the method 400.

The apparatus 100 (FIG. 1) and 300 (FIG. 3), and the methods 200 (FIG. 2) and 400 (FIG. 4) may be installed and implemented in private homes, public toilets, including, but not limited to, toilets in schools, office buildings, portable toilets, airports, airplanes, long-distance buses, schools and universities, sports complexes, medical clinics, shopping malls, or parks.

The steps shown in FIG. 4 are for illustration only. The order of one or more steps may be changed, and one or more steps may be omitted or added without deviating from the scope and the spirit of the invention.

By using suspension of air in soap solution and rinse water, the instant invention achieves more effective cleaning than the prior art method of using toilet paper alone, using even less soap than using soap solution. By gentle wiping of the wet areas with toilet paper, the instant invention prevents or significantly reduces the inflammation, itchiness bleeding caused by rough rubbing by dry toilet paper in the prior art method. By using gravity drainage, the instant invention also makes rinsing by water possible in squat toilets in parts of the world where water under pressure is unavailable.

The apparatus of FIG. 1 and FIG. 3, and the methods of FIG. 2 and FIG. 4 can also be used in cleaning frontal private areas in both males and females, the cleaning of which may require fewer steps than those required for the perineal area. As shown in Example 3, in cleaning male frontal private part with soap solution, step 203 (wiping with toilet paper after soap solution cleaning) and step 204 (checking if toilet paper is clean after washing with soap solution) may be omitted, and only step 202 (spraying with soap solution), step 205 (rinsing with water) and step 206 (drying with toilet paper) in FIG. 2 are completed. For cleaning female frontal private parts, all or some of the steps in FIG. 2 and FIG. 4 may be followed depending on period: regular or menstruation.

The method may also be used as a portable cleaning method by packing the soap and the water reservoirs in a backpack or attaching to a waist belt.

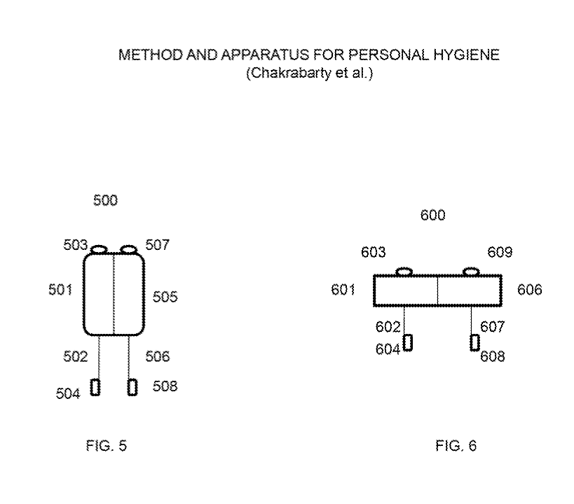

FIG. 5 illustrates how the method of this invention may be incorporated in a backpack 500 in which chamber 501 contains the dilute soap solution. Tube 502 is for gravity drainage of soap solution with a nipple, a pump or a valve 504 attached to the end of it. The cap 503 is to fill the chamber with a dilute soap solution. Chamber 505 contains water with tube 506 for gravity drainage of rinse water with a nipple, a pump or a valve 508 attached to the end of it. The cap 507 is to fill the chamber with rinse water. Each tube may be connected to an elastic material (not shown in FIG. 5) that allows the tube to be pulled out from the backpack when needed and retracted back into the backpack when not needed.

FIG. 6 illustrates how the method of the invention may be incorporated in a waist belt 600 in which chamber 601 contains the dilute soap solution and tube 602 is for the gravity drainage of the soap solution with a nipple, a pump or a valve 604 attached to the end of it. Cap or lid 603 is to fill the chamber with a dilute soap solution. Chamber 606 contains rinse water with tube 607 for gravity drainage of rinse water with a nipple, a pump or a valve 608 attached to the end of it. Cap or lid 609 is to fill the chamber with rinse water. Each tube may be connected to an elastic material that allows the tube to be pulled out from the waist belt when needed and retracted back into the waist belt when not needed.

For outdoor use, the reservoirs containing soap solution and water along with the tubes may be hung from a tree branch or any available stand at an elevation above the waist level of the person, while seated on a toilet seat or in a squat position.

By using gravity drainage of soap solution and water from reservoirs, the instant invention makes the cleaning apparatus portable and the method suitable for use during hiking, camping and travelling.

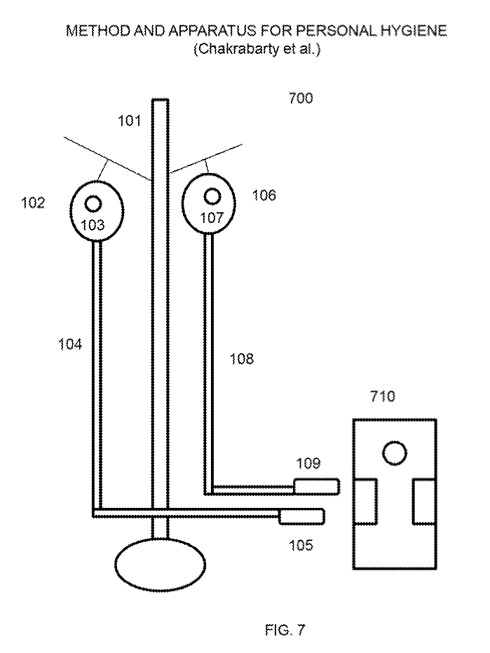

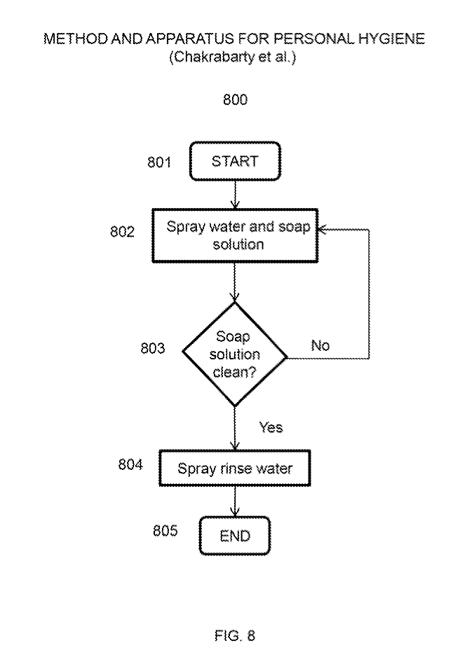

The method of this invention can also be implemented in a squat toilet, as shown in FIG. 7 and FIG. 8. The apparatus in FIG. 7 is similar to that in FIG. 1 except that squat toilet 710 has replaced western toilet 110, and toilet paper 111, which is not allowed in a squat toilet, has been taken out. In FIG. 8, the cleaning process 800 starts at 801. In step 802, cleaning is done, according to this invention, by spraying water and soap solution by gravity drainage from reservoir 106 and 102, respectively, for 10 to 60 seconds to the perineal and the adjacent areas. In step 803, a check for cleaning is made. If the waste water is not clean, water or soap solution spray continues. If the waste water is clean, the user moves to step 804 to spray the perineal and the adjacent areas with rinse water fed by gravity drainage from reservoir 106 for 5 to 30 seconds. The cleaning is completed by drying the area with a washable and reusable piece of cloth (not shown in FIG. 8). Alternatively, hot air supplied from a blower may be used to dry the areas. The cleaning process ends at step 805.

By eliminating scrubbing by hand during the soap solution or the rinse water wash, the instant invention obviates one of the main drawbacks of the perineal and the adjacent areas cleaning in a squat toilet. By not using toilet paper, the instant invention also meets the requirement of a squat toilet that toilet paper not be used. By using gravity drainage, the instant invention also makes cleaning by soap solution and water possible in squat toilets in parts of the world where water under pressure is unavailable.

The steps shown in FIG. 8 are for illustration only. The order of one or more steps may be changed, and one or more steps may be omitted or added without deviating from the scope and the spirit of the invention.

For the squat toilet, the soap solution-air suspension may also be used in lieu of the soap solution spray to clean the perineal and the adjacent areas. The steps to practice this comprise applying the soap solution-air suspension from container 301 in FIG. 3 directly to the perineal and the adjacent areas, rinsing the said areas with water fed by gravity drainage from reservoir 106 in FIG. 3, and drying the cleaned areas with a washable and reusable piece of cloth, or with a blow dryer.

Recognizing that the target areas for cleaning are very sensitive areas—some with mucous membranes—the soaps for cleaning in this invention are preferably gentle natural soaps, although synthetic soaps may also be used, provided they are safe for human skin and for the environment. The natural soaps are made from the saponification reaction of olive oil, palm oil, coconut oil, soybean oil, aloe vera oil, tea tree oil, avocado oil, hemp oil, canola oil or other natural oil with lye (sodium or potassium hydroxide). In some soap making process, more oil than is needed for the saponification reaction may be included to add moisturizing effect to the soap.

The amount of soap used to practice the method of this invention is reduced to mitigate the risk of residual soap causing skin irritation. The soap concentration for effective cleaning is only from 0.05 to 2.0 wt % in water, although higher concentration may be used. For a 0.3 wt % soap solution in water, only 0.0027 grams of residual soap is estimated to be in the target areas after soap solution application (step 202 in FIG. 2) and wiping with a toilet paper (step 203 in FIG. 2). The residual soap would reduce to undetectable level after rinsing with water (step 205 in FIG. 2) and drying with a toilet paper (step 206 in FIG. 2).

The soap concentration for making the soap-air suspension is also very low, falling in the range of 0.05 to 2.0 wt % soap in the soap water solution, although higher soap concentrations may be used. For a soap solution concentration of 0.32 wt % in water, the amount of soap in the soap-air suspension taken on the toilet paper in step 402 in FIG. 4 is estimated to be 0.0045 grams. This small amount of soap would be further reduced to undetectable level of residual soap in the cleaned areas after the first wiping of the suspension with a toilet paper (step 403 in FIG. 4), water rinsing (step 405 in FIG. 4) and drying with a toilet paper (step 406 in FIG. 4).

The advantages of the instant invention over prior art are many and include compatibility with a western toilet or a squat toilet, operability with atmospheric pressure water, portability for outdoor use, lower cost, easier installation, more effective cleaning, and comfortable cleaning for people suffering from persistent itches, inflammation, or hemorrhoids.

The nine examples below show how the method and the apparatus of the instant invention may be used to clean the perineal and the adjacent areas.

The toilet paper used in the following examples was President's Choice 3-ply ULTRA, distributed by Loblaws Inc., Montreal, Canada, but other toilet paper distributed by other corporations or made by other manufacturers may also be used in practicing the invention.

### EXAMPLES

### Example 1

### Cleaning of Perineal Area by Dilute Soap (Multiple Soaps) and Water, According to the First Embodiment of the Invention

A multiple soap solution was prepared by blending flakes of equal proportions of olive oil, aloe vera, tea-tree and carbolic soaps with distilled water first for 15 seconds at a speed 2 setting, then for 60 seconds at a speed 4 setting and finally for another 60 seconds at a speed 4 setting in a KitchenWorks blender at room temperature. Further dilution of the 3.2 wt % soap solution in distilled water resulted in a 0.32 wt % multiple soap solution in water. The dilute soap solution was then poured into container 102 (FIG. 1), which was 104 cm above the toilet seat 110 in FIG. 1.

The subject performing the cleaning test had consistently experienced itchiness and inflammation of the perineal area caused by rubbing of dry toilet paper against sensitive area.

The subject followed step 202 of FIG. 2 and sprayed the soap solution over the perineal area by squeezing the nipple 105 of tube 104 for 5 seconds at a gravity drainage rate of 3.3 mL/s for a total soap solution usage of 17 mL, by sitting on the toilet seat.

The subject then followed step 203 of FIG. 2 by folding twice two serrated sections of the toilet paper and checked (step 204 of FIG. 2) if the paper was clean. Noticing it not clean, he repeated steps 202, 203 and 204 of FIG. 2, using another 17 ml of soap solution and noticed that the toilet paper was clean. After disposing of the toilet paper in the toilet bowl, he then followed step 205 of FIG. 2 and rinsed the area with tap water from reservoir 106, situated at an elevation of 88 cm above the toilet seat, for 5 seconds. The gravity drainage rate of water was 2 mL/sec, resulting in a total water usage of 10 mL. He then completed the cleaning by dabbing a toilet paper to dry the area (step 206 in FIG. 2). After disposing of the toilet paper in the toilet bowl, he washed his hands with the soap solution from reservoir 102 and the water from reservoir 106. The total cleaning time was only 90 seconds.

In sharp contrast to the prior art toilet paper cleaning, the method of the instant invention left the perineal area completely clean and the subject did not experience irritation, itchiness or inflammation after the cleaning.

### Example 2

### Cleaning of Perineal Area by Dilute Soap (Single Soap) and Water According to the First Embodiment of the Invention

A 0.3 wt % olive oil soap (single soap) solution was prepared by blending flakes of olive oil soap in distilled water first for 15 seconds at a speed 2 setting, then for 60 seconds at a speed 4 setting and finally for another 60 seconds at a speed 4 setting in a KitchenWorks blender at room temperature. The dilute soap water was then poured into container 106 (FIG. 2), which was 104 cm above the toilet seat 110 (FIG. 1).

The subject performing the cleaning test had consistently experienced itchiness and inflammation of the perineal areas caused by rubbing of dry toilet paper against sensitive areas.

The subject followed step 202 of FIG. 2 and sprayed the soap solution over the perineal area by squeezing nipple 105 of tube 104 for 5 seconds at a gravity drainage rate of 3.3 mL/s for a total soap solution usage of 17 mL.

He then followed step 203 of FIG. 2 by folding twice two serrated sections of the toilet paper, wiping the soap-washed area and checking (step 204 of FIG. 2) if the paper was clean. Noticing it not clean, he then repeated steps 202, 203 and 204 of FIG. 2 one more time, using another 17 mL of soap solution and noticed that the toilet paper was clean that time. He then followed step 205 of FIG. 2 and rinsed the area with tap water from reservoir 106, situated at an elevation of 88 cm above the toilet seat 110 (FIG. 1) for 5 seconds. The gravity drainage rate of water was 2 mL/sec, resulting in a total water usage of 10 mL. After disposing of the toilet paper in the toilet bowl, he washed his hands with the olive soap solution from reservoir 102 and the water from reservoir 106. The total cleaning time was 90 seconds.

In sharp contrast to the prior art toilet paper cleaning, the method of the instant invention left the perineal area completely clean and the subject did not experience irritation, itchiness or inflammation after the cleaning.

Examples 1 and 2 show that the first embodiment of this invention cleans gently and effectively the perineal area using a small amount of dilute soap (single soap) solution and rinse water in a short time, drawbacks of the prior art cleaning by toilet paper alone. The examples also show that the method uses atmospheric pressure soap solution and water, both drained by gravity from reservoirs. The examples also illustrate the compatibility of the method of the invention with a western toilet.

### Example 3

### Cleaning of Perineal Area with Soap (Multiple Soaps) Solution—Air Suspension and Water, According to the Second Embodiment of the Invention

To clean the perineal area according to the second embodiment of the invention, the subject from example 1 followed step 402 (FIG. 4) and pumped three drops (each measuring ˜2 cm×2 cm×0.5 cm) of the soap solution-air suspension from bottle 301 (FIG. 3) on the twice folded two serrated sections of the toilet paper. The concentration of the multiple soap solution—as prepared in example 1—in container 301 was 0.32 wt % in distilled water. Container 301 had a device 302 (FIG. 3) for making a soap solution-air suspension.

He then followed step 403 of FIG. 4 to gently wipe the perineal area with the toilet paper containing the soap solution-air suspension, checked if the toilet paper was clean (step 404 in FIG. 4) and repeated steps 402 to 404 in FIG. 4 one more time to until the paper was clean. After disposing of the toilet paper in the toilet bowl after each wiping, he next rinsed the area with water (step 405 in FIG. 4) for 5 seconds with 10 mL of water at a gravity drainage rate of 2 mL/s and dabbed the area gently with a toilet paper (step 406 in FIG. 4) to dry the area. After disposing of the toilet paper in the toilet bowl, he washed his hands with the soap solution-air suspension from container 301 and water from reservoir 106.

The total cleaning time was 90 seconds. After cleaning, the subject felt fresh and Clean, and did not experience any of the ill effects (e.g., irritation, itchiness or inflammation) of the prior art cleaning by toiler paper.

### Example 4

### Cleaning of Perineal Area with Soap (Single Soap) Solution—Air Suspension and Water According to Second Embodiment of the Invention

The 0.3 wt % olive oil soap solution in distilled—prepared as in example 2—was poured into container 301 of FIG. 3 which had a device 302 for making a soap solution-air suspension. The same subject from example 1 followed step 402 of FIG. 2 and pumped three drops (each ˜2 cm×2 cm×0.5 cm) of the soap solution-air suspension onto the twice-folded two serrated sections of the toilet paper.

He then followed step 403 in FIG. 4 to gently wipe the perineal area and repeated steps 402 to 404 one more time to notice the toilet paper was clean. After disposing of the toilet paper in the toilet bowl after each wiping, he then completed the cleaning by rinsing the area with 5 seconds of water spraying at a gravity drainage rate of 2 mL/s for a water usage of 10 mL. He dabbed the area gently with a toilet paper (step 406 in FIG. 4) to dry the area. After disposing of the toilet paper in the toilet bowl, he washed his hands with the soap solution from reservoir 102 and water from reservoir 106.

The total cleaning time in this example was 95 seconds. After cleaning, the subject felt fresh and experienced no irritation, itchiness or inflammation of the area.

Examples 3 and 4 show that the second embodiment of the invention also provides gentler and more effective cleaning of the perineal area using small amounts of dilute soap (multiple soaps) solution-air suspension and rinse water in a short time, obviating the drawbacks of the prior at cleaning by toilet paper.

### Example 5

### Cleaning of Male Frontal Private Part with Soap (Multiple Soaps) Solution and Water, According to the First Embodiment of the Invention

To clean the male frontal private part after passing water, the subject followed step 202 of FIG. 2 and took the end of tube 104 and squeezed the nipple for three seconds to wash the private part with 0.32 wt % natural soap solution as prepared in example 1. At a gravity drainage rate of 3.3 mL/s, the total solution sprayed was 11 mL. The subject then skipped steps 203 and 204 of FIG. 2 and went to step 205 and rinsed the soap solution-drenched area with water fed by gravity drainage from reservoir 106 at a rate of 3.3 mL/min by squeezing the nipple 109 at the end of tube 108 for three seconds, letting the waste water drip into the toilet bowl below. He completed the cleaning process, by following step 206 of FIG. 2 by gently dabbing the cleaned wet area with a toilet paper. After disposing of the toilet paper in the toilet bowl, he washed his hands with the soap solution from reservoir 102 and the water from reservoir 106.

The cleaning took only 15 seconds and used only 11 mL of soap solution and 6 mL of rinse water. No splashing occurred during the cleaning by the fluids that drained gently by gravity.

This example shows that the first embodiment of the invention gently and effectively cleans the male frontal private part using a small amount of dilute soap (multiple soaps) solution and rinse water in a very short time, resulting in good personal hygiene.

### Example 6

### Cleaning of Male Frontal Private Part with Soap (Single Soap) Solution and Water According to the First Embodiment of the Invention

To clean the male frontal private part after passing water according to the first embodiment of the invention, the subject from example 6 followed step 202 of FIG. 2 and took the end of tube 104 and squeezed the nipple 105 for three seconds to wash the private part with the 0.32 wt % olive oil soap solution, as prepared in example 2, letting the waste solution drip into the toilet bowl below. The soap solution flowed at a gravity drainage rate of 3.3 mL/s for a total volume of 11 mL.

The subject then skipped steps 203 and 204 of FIG. 2 and went to step 205 and rinsed the area with gravity drained water from reservoir 106 by squeezing the nipple 109 at the end of tube 108 for three seconds at a water drainage rate of 2 mL/s, using only 6 mL of solution. He followed step 206 of FIG. 2 by gently dabbing the cleaned area with a toilet paper. After disposing of the toilet paper in the toilet bowl, he washed his hands with the olive soap solution from reservoir 102 and water from reservoir 106.

The cleaning took only 15 seconds and used up only 11 mL of soap solution and 6 mL of rinse water. No splashing occurred during the cleaning by the fluids that drained by gravity. The subject achieved good personal hygiene and cleanliness.

Examples 5 and 6 show that using the first embodiment of the invention the male frontal private part can be cleaned using small amounts of dilute soap solution and rinse water in a very short time.

### Example 7

### Cleaning of Male Frontal Private Part with Soap (Multiple Soaps) Solution-Air Suspension and Water According to the Second Embodiment of the Invention

To clean the male frontal private part after passing water according to the second embodiment of the invention, the subject followed step 402 of FIG. 4 and pumped one drop (˜3 cm×3 cm×0.5 cm) of the soap solution-air suspension from bottle 301 (FIG. 3) on twice-folded two-serrated sections of the toilet paper. The concentration of the multiple soap solution—as prepared in example 1—in bottle 301 was 0.32 wt % in water. The subject then wiped (step 403 in FIG. 4) the private part with the soap suspension on the toilet paper. He skipped steps 403 and 404 in FIG. 4 and followed step 405 in FIG. 4 with three seconds of water rinse at a water gravity drainage rate of 2 mL/s, using only 6 mL of water. He then dabbed the part gently with a dry toilet paper (step 406 in FIG. 4). After disposing of the toilet paper in the toilet bowl, he washed his hands with the soap-air suspension from bottle 301 and water from reservoir 106.

The total cleaning took 22 seconds and used only 4.5 mL of soap-air suspension and 6 mL of rinse water that left the cleaned area free of soap residue.

### Example 8

### Cleaning of Male Frontal Private Part with Soap (Single Soap) Solution-Air Suspension and Water According to Second Embodiment of the Invention

To clean the male frontal private part after passing water according to the second embodiment of the invention, the subject followed step 402 of FIG. 4 and pumped one drop (˜3 cm×3 cm×0.5 cm) of the olive soap solution-air suspension from bottle 301 (FIG. 3) on twice-folded two-serrated sections of a two-ply toilet paper. The concentration of the single soap solution—as prepared in example 2—in bottle 301 was 0.32 wt % in water. The subject then wiped (step 403 in FIG. 4) the private part with the soap suspension on the toilet paper. After disposing of the toilet paper in the toilet bowl, he skipped steps 403 and 404 in FIG. 4 and followed step 405 in FIG. 4 with three seconds of water rinse at a water gravity drainage rate of 2 mL/s, using only 6 mL of water. He then dabbed the part gently with a dry toilet paper (step 406 in FIG. 4). After disposing of the toilet paper in the toilet bowl, he washed his hands with the soap-air suspension from bottle 301 and water from reservoir 106.

The total cleaning took 20 seconds and used only 2 mL of soap solution-air suspension and 6 mL of rinse water. After cleaning, the subject felt fresh and experienced no irritation or itchiness.

Examples 7 and 8 show that the second embodiment of this invention gently and effectively cleans the male frontal private part using a small amount of dilute soap (single soap) solution-air suspension and rinse water in a very short time. These examples also suggest that the same embodiment can also be used by a female subject.

### Example 9

### Cleaning of Perineal Area with Soap (Multiple Soaps) Solution and Water in a Squat Toilet

An apparatus according to FIG. 7 was installed for the purpose of demonstrating the effectiveness of the invention in cleaning perineal area in a squat toilet. The subject followed the steps in FIG. 8, by spraying the said area for 30 seconds with water (step 802) drained by gravity from reservoir 106, by spraying the area for 15 seconds with a 0.32 wt % multiple soap solution (step 804) drained by gravity from reservoir 102 and then rinsing the area for 15 seconds with water (step 805) drained by gravity from reservoir 106. Unlike the prior art perineal cleaning in a squat toilet, the subject did not use hand for scrubbing the area in any of those steps. He completed the cleaning process using an 11.5 inch×11.5 inch 100% cotton towel to dry the area. The towel was clean confirming that the method of cleaning according to the instant invention was effective. The total cleaning time including drying with the cloth towel was 120 seconds.

The subject did not experience any irritation, itchiness or inflammation in the area after the cleaning.

This example shows that the instant invention cleans perineal area in a squat toilet using soap solution and water—both drained by gravity—without requiring high pressure water, toilet paper (which cannot be disposed of in a squat toilet) or hand contact with the area to be cleaned, thereby obviating the drawbacks of the prior art methods in using a squat toilet.

We claim:

1. A method for cleaning of the perineal and the adjacent areas for personal hygiene after using a toilet, the method comprising the steps of:
a) spraying a dilute soap solution delivered by gravity drainage to the said areas;
b) wiping the dilute soap solution sprayed wet areas with toilet paper;
c) discarding the used toilet paper in the toilet;
d) rinsing the dilute soap solution sprayed wet areas with water delivered by gravity drainage;
e) drying the water-rinsed wet areas with toilet paper;
f) discarding the used toilet paper in the toilet and flushing the toilet; and
g) washing the hands with the soap solution and the water, both delivered by gravity drainage.

2. The method according to claim 1, wherein the soap solution is prepared by blending distilled water, rain water, tap water or water from other sources with soaps made from olive oil, palm oil, soybean oil, canola oil, coconut oil, tea tree oil, jojoba oil, aloe vera oil, and other natural oils, each soap used alone or in combination with others.

3. The method according to claim 2, wherein the concentration of soap in water is 0.05 to 2.0 wt %.

4. An apparatus for cleaning of the perineal and the adjacent areas according to claim 1, the apparatus comprising a first reservoir to hold the soap solution, a second reservoir to hold the water, and a stand from which to hang the reservoir holding the soap solution and the reservoir holding the water.

5. The apparatus according to claim 4, wherein the soap solution and the water flow by gravity drainage through a tube from the respective reservoir.

6. The apparatus according to claim 4, wherein the reservoir holding the soap solution and the reservoir holding the water are separate entities or two chambers of the same container, each with its own tube for the gravity drainage flow of each liquid.

7. The apparatus according to claim 4, wherein the gravity drainage flow of soap solution or water from each reservoir is initiated by squeezing a nipple, activating a pump, or by opening a valve, each of which is attached to one end of the tube connected to each reservoir holding the soap solution or the water.

8. The apparatus according to claim 7, wherein the tubes are flexible and made of plastic, rubber or braided stainless steel.

9. The apparatus according to claim 4, wherein the reservoir holding the soap solution and the reservoir holding the water are rigid, or deformable, and are made of plastics, rubber, clay, ceramics, composites, carbon steel, aluminum, stainless steel, or any other suitable materials.

10. The apparatus according to claim 4 is used with a western toilet or a squat toilet located in private homes, public areas, hospitals, medical clinic, community halls, schools and universities, airports, air planes and shopping malls.

11. The apparatus according to claim 4 is portable and used indoor in at least one bathroom, or outdoor by packing it in a motor vehicle, or by carrying the reservoirs and the tubes in a backpack or as a part of a backpack, or in a waist belt or as a part of a waist belt.

12. A method for cleaning of the perineal and the adjacent areas for personal hygiene, after using a toilet, the method comprising the steps of:
a) spraying a soap solution-air suspension on a layered toilet paper;
b) wiping the perineal and the adjacent areas with the layered toilet paper containing the soap solution-air suspension;
c) discarding the used toilet paper in the toilet;
d) rinsing the perineal and the adjacent areas with water;
e) drying the water-rinsed wet areas with toilet paper;
f) flushing the used toilet paper in the toilet; and
g) washing the hands with the soap solution-air suspension and water.

13. The method according to claim 12, wherein the soap solution is prepared by blending distilled water, rain water, tap water or water from other sources with soaps made from olive oil, palm oil, soybean oil, canola oil, coconut oil, tea tree oil, jojoba oil, aloe vera oil, or other natural oils, each soap used alone or in combination with others.

14. The method according to claim 12, wherein the concentration of soap in water is 0.05 to 2.0 wt %.

15. An apparatus for cleaning of the perineal and the adjacent areas according to claim 12, the apparatus comprising a soap solution-air suspension dispenser to hold the soap solution and a device to supply rinse water.

16. The apparatus according to claim 15, wherein the dispenser has a mixing device to the make the soap solution-air suspension.

17. The apparatus according to claim 15, wherein the rinse water is supplied by gravity drainage from a reservoir hung from a portable decorative stand.

18. The apparatus according to claim 15, wherein the rinse water is supplied from a water dispenser comprising a water bottle and an air sparger.

19. The apparatus according to claim 15, wherein the apparatus is used with a western toilet or a squat toilet located in private homes, public areas, hospitals, medical clinic, community halls, schools and universities, airports, air planes and shopping malls.

20. The apparatus according to claim 15, wherein the apparatus is portable and used indoor in at least one bathroom, or outdoor by packing it in a motor vehicle, or by carrying the reservoirs and the tubes in a backpack or as a part of a backpack, or in a waist belt or as a part of a waist belt.
